(19) United States
(12) Patent Application Publication
(10) Pub. No.: US 2008/0104279 A1
(43) Pub. Date: May 1, 2008

(54) Power supply

(75) Inventor: William Wong, Milton Keynes (GB)

Correspondence Address: HARRINGTON & SMITH, PC, 4 RESEARCH DRIVE, SHELTON, CT, 06484-6212, US

(73) Assignee: High Performance Enterprise PLC

(21) Appl. No.: 11/973,964

(22) Filed: Oct. 11, 2007

(30) Foreign Application Priority Data
Oct. 12, 2006 (TW) 095217998

(51) Int. Cl. G06F 3/00

(52) U.S. Cl. 710/1

(57) ABSTRACT

In a power supply with a data transmission module, the power supply includes a power transforming module and a data transmission module. The power transforming module is provided for converting mains electricity into an electric power applicable to electronic components and has a power input terminal connected to the mains electricity, and a power output terminal connected to the data transmission module and electronic components. A data conversion module has an end connected to a control module of a computer system and another end connected to an external data transmission interface of the power supply. In an application, an external electronic device can exchange, transmit and access data with the computer system through the external data transmission interface and a data transmission module of the power supply to expand the connection of computer peripherals. The power supply also provides an electric charging function through the external data interface.

### FIELD OF THE INVENTION

The present invention relates to a power supply with a data transmission module, and more particularly to an electric charging power supply having a data transmission module and a data interface in a power supply of a computer system for supplying electric charging power to an external electronic device, so as to achieve the function of exchanging data with the computer system through an external data transmission interface of the data transmission module.

### BACKGROUND TO THE INVENTION

As computer peripheral has become a necessary tool for our life and work, and its functions are expanded and integrated rapidly. In addition to a computer system, many peripherals including a mouse, a keyboard, a speaker, a printer, a monitor, an external storage device, a MP3 player, and a digital camera, etc become parts of the computer system, and these peripherals use different types of data lines and connectors for their connections. There are various different types of connectors and some of the common ones include Serial Port, Parallel Port, SCSI Port and PS2 connectors. Since there are so many specific types of connectors, the complexity and cost of a computer system are increased, and the performance and data transmission rate of the computer system can no longer meet user requirements. In recent years, the computer industry promotes an industrial standard such as USB and IEEE 1394 and plans to integrate different interfaces into a simple socket, in order to make the life of computer users much easier.

Since many electronic component manufacturers support the USB or IEEE 1394 data interface, a standard computer usually reserves 2 to 3 built-in USB data interfaces. However, the existing data interfaces are usually occupied already, and users have to unplug one of temporarily unused electronic devices from one of the data interfaces before installing a new electronic device, and thus the traditional way causes tremendous inconvenience to users. Furthermore, users may find insufficient power supply when they use the built-in data interfaces, and thus an external USB hub with several data interfaces is generally adopted to provide sufficient data interfaces and solve the problem of having insufficient power, but such arrangement incurs an additional cost to consumers. Many portable electronic devices including mobile phones, MP3 players and digital cameras provide a USB charger, and existing computers usually do not provide a charging power supply for external devices, and thus it is necessary to install different types of adapters into the sockets of utility electricity to meet user requirements and thus causing unnecessary waste and tremendous inconvenience.

### SUMMARY OF THE INVENTION

In view of the shortcomings of the prior art, the inventor of the present invention based on years of experience to conduct extensive researches, experiments and modifications, and finally developed a power supply in accordance with the present invention.

An aim of the present invention is to overcome the shortcomings of the prior art by providing a power supply with a data transmission module to solve the problems of having insufficient data transmission interfaces for computer applications as well as providing a function of electrically charging an external electronic device.

Another aim of the present invention is to provide a power supply with a data transmission module, and the data transmission module includes an external data transmission interface for connecting an external electronic device.

A further aim of the present invention is to provide a power supply with a data transmission module, and the external data transmission interface can provide more than one external data interfaces for connecting external electronic devices through data lines.

Another aim of the present invention is to provide an external data transmission interface of a power supply to a Bluetooth module or a wireless module for pairing and transmitting data with an external electronic device.

Another aim of the present invention is to provide a data transmission module of a power supply connected directly with an external electronic device, so as to solve the problem of having insufficient power supply when a computer control system is connected.

Another aim of the present invention is to provide a data interface on a power supply for directly and electrically charging an external electronic device.

To achieve the foregoing objectives, the technical measures adopted by the invention include an installation of a data transmission module to a power supply of a computer system, and the data transmission module has an external data transmission interface that can be connected to more than one external electronic devices, so as to increase the number of data interfaces for connecting external peripherals of the computer system and provide sufficient data interfaces to meet user requirements.

### DESCRIPTION OF THE DRAWINGS

Embodiments of the invention will now be described, by way of example, with reference to the accompanying drawings, of which:

FIG. 1 is a schematic view of a power supply in accordance with the present invention; and

FIG. 2 is a perspective view of the FIG. 1 power supply.

### DESCRIPTION OF THE PREFERRED EMBODIMENTS

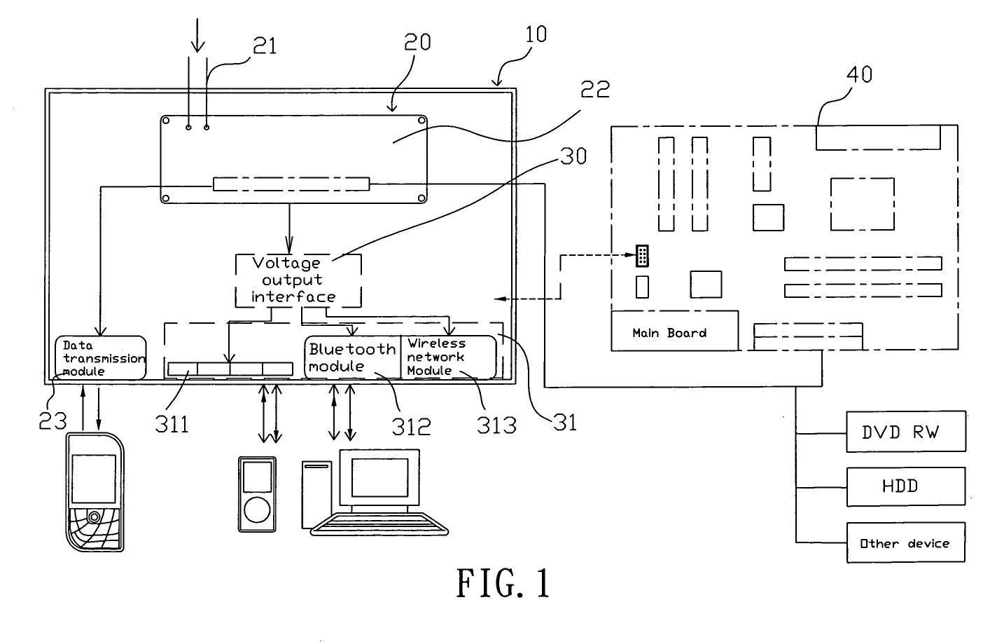

Referring to FIG. 1, a data transmission module and an electric charging device has a power supply 10, and the power supply 10 includes a power transforming module 20 and a data transmission module 30; wherein the power transforming module 20 is comprised of a power input interface 21, a power transformer 22 and a voltage output interface 23, and the power input interface 21 is connected to an external power supply, and the power input interface 21 of this preferred embodiment is a general utility electricity interface; and the power transformer 22 is provided for converting utility electricity into the electric power such as 5V or 12 V required by an electronic device. An end of the power transformer 22 is connected to the power input interface 21 and another end of the power transformer 22 is connected to the voltage output interface 23. The voltage output interface 23 connects the converted electric power to a data transmission module 30, a computer control system 40, and each electronic component.

In FIG. 1, the data transmission module 30 is provided for transmitting and converting data communication signals (and the data transmission module of this embodiment is a hub), and an end of the data transmission module 30 is connected to an external data transmission interface 31, and the external data transmission interface 31 can be connected to more than one external data interfaces 311, and the external data interface 311 is installed on a casing of the power supply 10; and another end of the data transmission module 30 is connected to a computer control system 40; and the external data transmission interface 31 of the data transmission module 30 can be connected to an external electronic device on the external data interface 311 and the computer control system 40 for exchanging and accessing data. In addition to enhancing the expandability of the computer system for connecting external electronic devices, this arrangement also can supply electrical power directly from the power supply 10, so as to solve the problem of having insufficient power when the computer control system 40 is connected.

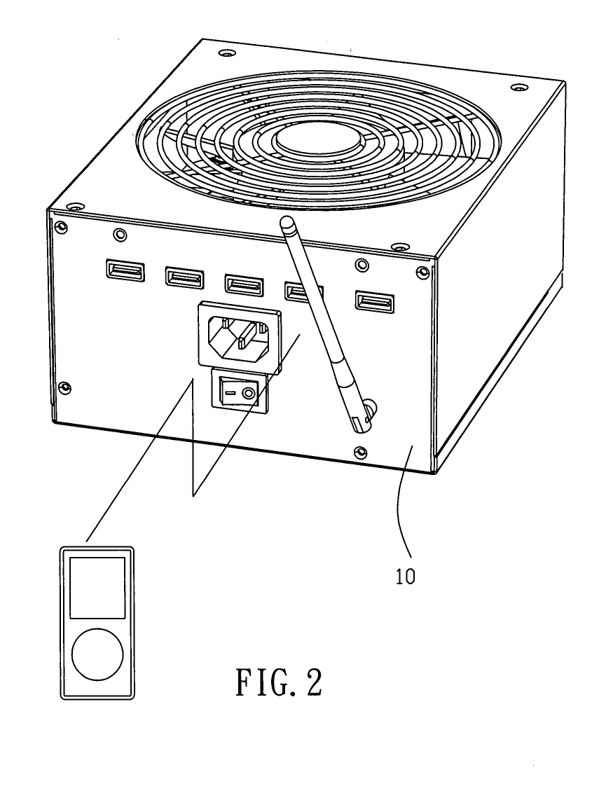

Referring to FIGS. 1 and 2 for another embodiment of the invention, a data transmission module 30 is provided for transmitting and converting wireless data communication signals, and the data transmission module 30 is connected to an external data transmission interface 31, and the external data transmission interface 31 provides a transmission protocol of a Bluetooth module 312 or a wireless network module 313 for transmitting data with an external wireless electronic device by the Bluetooth or wireless network communication protocol; and another end of the data transmission module 30 is connected to a computer control system 40. By the external data transmission interface 31 and the data transmission module 30, an external electronic device paired and connected with the Bluetooth module 312 or the wireless network module 313 can exchange and access data with the computer control module 40.

Referring to FIGS. 1 and 2 for an application of the invention, an external electronic device such as a scanner, an earphone or a printer is connected to an external data interface 311, or a wireless electronic device is paired with the Bluetooth module 312 or the wireless network module 313, and then the external data transmission interface 31 and the external data transmission module 30 are used for communicating with the computer control system 40 and become one of the external devices (as shown in FIG. 2).

In the meantime, the voltage output interface 23 in the form of a data interface can be installed on a casing of the power supply 10, so that the power input terminal of an external electronic device (such as a mobile phone, a PDA or a MP3 player) can be connected to the data interface for performing an electric charging directly.

In summation of the above description, the power supply with a data transmission module in accordance with the present invention has a simple structure and features a convenient application that encourage users to use such device, and the invention definitely enhances the performance and overcomes the shortcomings of the prior art, and further complies with the patent application requirements, and thus the invention is duly filed for patent application.

While the invention has been described by way of example and in terms of preferred embodiments, it is to be understood that the invention is not limited to such arrangement, and various modifications and similar arrangements and procedures are intended to be covered by the scope of the appended claims and should be accorded the broadest interpretation so as to encompass all such modifications and similar arrangements and procedures.

What is claimed is:

1. A power supply, comprising:
a power supply, for supplying electric power to an electronic component connected to a computer system, and having a power transforming module disposed therein, with an end of said power transforming module being coupled to an external power input interface outside a casing for transforming an electric power required by said electronic component, and another end of said power transforming module being coupled to a voltage output interface; and
a data transmission module, installed on said power supply, for converting and transmitting data signals for a computer control system and an external electronic device, with an end of said data transmission module being coupled to said computer control system, and another end of said data transmission module being coupled to an external data transmission interface;
such that if said external electronic device is connected to said external data interface, said external data transmission interface and said data transmission module will be able to convert, transmit and access data signals with said computer control system.

2. The power supply of claim 1, wherein said data transmission module is a USB hub.

3. The power supply of claim 1, wherein said external data transmission interface is a USB data interface.

4. The power supply of claim 1, wherein said external data transmission interface is a Bluetooth module.

5. The power supply of claim 1, wherein said external data transmission interface is a wireless network module.

6. The power supply of claim 1, wherein said voltage output interface is of a data interface type for directly and electrically charging an external electronic device.
